(19) United States
(12) Patent Application Publication
(10) Pub. No.: US 2007/0156567 A1
(43) Pub. Date: Jul. 5, 2007

(54) Automated method and system for market making, centralized margin facility and clearing of synthetic orders

(75) Inventors: Peter M. Odintsov, Daly City, CA (US); James R. Soderborg, San Francisco, CA (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: Peter James SBST, Inc. (a California Corporation)

(21) Appl. No.: 11/324,791

(22) Filed: Jan. 3, 2006

(51) Int. Cl. G06Q 40/00

(52) U.S. Cl. 705/37

(57) ABSTRACT

An automated method and system achieves higher than currently possible leverage in trading synthetic positions (e.g., Asset Packages) consisting of cash equivalent and its derivative. The derivative leg of the Asset Package is used as collateral for the whole package to the extent that it hedges the market risk of the synthetic position. The Asset Package Market Maker assembles (quotes) synthetic positions based on the underlying markets' quotes, which includes a discount (embedded margin). The amount of the discount is based on the value of package collateral, such as the put strike in case of a synthetic call position. The discounted synthetic position is then traded in the virtual asset package market, established and made by such a market maker on a real-time basis. The method and system are applicable to various assets and related derivatives. The method and system herein can be used for trading any asset, right or liability not just securities, equities, derivatives or other like instruments.

### FIELD OF INVENTION

The present invention relates generally to electronic trading systems, and more particularly to an electronic trading system for processing synthetic and complex trading orders.

### BACKGROUND OF THE INVENTION

Examples of trading strategies that result in synthetic and complex trading orders include synthetic long calls, reversal conversions, etc. The Federal Reserve regulates the extension of credit for investment in securities in the United States. The Federal Reserve's Regulation T applies to margin lending by brokers and dealers, whereas the Federal Reserve's Regulation U applies to margin lending by entities other than broker dealers, most commonly, commercial banks. At present, margin trading in stocks and other securities, including the ones used in synthetic positions consisting of cash equivalents and their derivatives requires an initial margin of 50% of the purchased securities' market value and a variable margin subject to market conditions throughout the life of the position. The shortage of funds to satisfy the minimum balance (i.e., maintenance margin) requirement can result in a margin call, thereby prompting the investor to make the necessary deposit into the investor's margin account. If the margin deficiency is not redeemed within the allotted time period, the creditor is allowed to liquidate a portion of the position to bring the negative balance in the margin account to zero.

High demands for qualifying collateral and the continuous exposure to accelerated losses during market moves negative to the position make the existing margin trading mechanism very dangerous and largely inaccessible to an average or unsophisticated investor (such as one taking a synthetic call position for the purpose of hedging stock ownership risks or gearing into an equity position).

In recent years, several changes have been made to Regulations T and U that have resulted in more flexible margin lending practices along with commercial banks' expansion into providing margin facilities collateralized by securities traded overseas. Also novel loan products have been developed, such as a Flexible Investment Facility by Smith Barney Citigroup Australia Pty Limited and similar products by Leveraged Equities (Australia), etc. Additionally, major clearing houses in the United States and Europe have started to implement cross margining measures to reduce margin requirements for their clearing members and other professional traders.

Nevertheless, an average synthetic position investor still does not have access to significant leverage of his/her funds though the combined market risk of the position may be substantially lower than that of its individual components. Therefore, the problem remains substantially unresolved for the majority of public traders.

The present invention is therefore directed to the problem of optimizing the leverage of a complex position for all traders.

### SUMMARY OF THE INVENTION

The present invention solves these and other problems by inter alia providing a system and method for a centralized margin lending mechanism in market making of complex asset packages. Examples of complex asset packages are described in U.S. patent application Ser. No. 10/457,792 filed Jun. 9, 2003, which is hereby incorporated by reference as if repeated herein in its entirety, including the drawings.

The solutions based on the present invention result in overall increased efficiency and liquidity of the asset packages market as well as in the underlying (e.g., equity and derivative) markets. Such solutions also free up a substantial amount of funds currently tied up in equity components of synthetic positions held in brokerage accounts concomitant with an increase in the ability to leverage such funds by the investors without changing the risk profile of their investment holdings.

Among the biggest benefits of the present invention is the ability to use maximum leverage of funds by equity hedgers, which is currently substantially limited by initial and maintenance margin requirements of the Regulation T. The system of the present invention provides hedgers an opportunity to leverage funds in a manner similar to professional traders, while leaving the speculative margin mechanism in the realm of Regulation T, in which it belongs.

According to one aspect of the present invention, a computer implemented method for leveraging a hedged synthetic asset package includes linking a centralized margin facility to an asset package market making process and embedding leverage achieved through centralized margin lending into a price of a leveraged asset package as a discount.

According to another aspect of the present invention, a computer implemented method for processing trades of two or more related assets, rights or liabilities includes creating a market in a combined asset, right or liability composed of the two or more related assets, rights or liabilities, and purchasing one or more of such related assets, rights or liabilities on margin by a market maker as needed to satisfy demand in the market in the combined asset, right or liability.

According to another aspect of the present invention, a computer implemented method for providing instantaneous leverage of funds when trading a hedged synthetic asset package includes performing a price discovery process of the hedged synthetic asset package, embedding a margin lending process into the price discovery process, and conducting leverage upstream relative to the price discovery process.

According to another aspect of the present invention, a computer implemented method for trading an asset, right or liability includes providing a centralized margin lending facility that allows incorporating leveraging of funds into a process of price discovery and generation of quotes (hereinafter, a quote means a single price and/or bid and ask quotation), market making of asset packages, and obtaining a virtually risk-free rate of interest charged upfront upon execution of an asset package order.

According to another aspect of the present invention, a computer implemented method for trading a combination of an asset, right or liability and a related asset, right or liability includes receiving an order to trade the asset, right or liability and the related asset, right or liability by an asset package market maker that is exempt from a margin requirement, and creating a market in an asset package composed of the asset, right or liability and the related asset, right or liability based on a purchase of the asset, right or liability on margin by the asset package market maker.

According to another aspect of the present invention, an apparatus for trading instruments includes a market maker and a trading order interface. The market maker performs a virtual dynamic securitization of a synthetic position, which includes one or more cash equivalent instruments and one or more derivatives (e.g., a synthetic long call) into a leveraged asset package. The trading order interface is coupled to the market maker and accepts one or more trades in the leveraged asset package from one or more traders, including one or more non-professional traders. The market maker may include an asset package price discovery module to determine a price for the leveraged asset package. The market maker may also include a quote dissemination module to distribute a quote for the leveraged asset package. The market maker may also include an asset package execution module to purchase a first type of instrument of the synthetic position on margin from a stock (or other cash equivalent instrument) exchange and a second type of instrument of the synthetic position from a derivative exchange. The apparatus may also include a margin lending and clearing facility to finance margin debt on the leveraged asset package incurred by the market maker.

According to another aspect of the present invention, a method for trading an asset, right or liability includes generating a quote for an asset package that includes an asset, right or liability cash instrument and a derivative of the asset, right or liability, and embedding in the quote for the asset package a cost of margin financing of at least one leg of the asset package before the asset package is purchased.

### BRIEF DESCRIPTION OF THE DRAWINGS

FIG. 1 depicts a block diagram of an existing manual process required to execute a combination order in order to acquire a synthetic position, e.g., a synthetic long call that is subject to Regulation T.

FIG. 2 depicts a block diagram illustrating the process of generating leverage in trading a synthetic position, for example, a synthetic long call, that is superior to currently available methods in terms of the lowest margin equivalent available for trading such instruments according to one aspect of the present invention.

FIG. 3 depicts a flow diagram of an exemplary embodiment of a method and system for market making and margin lending and clearing of the asset packages according to another aspect of the present invention showing the operation of such a system in its dynamic form.

FIG. 4 depicts a flow diagram of an exemplary embodiment of the central aspects of the system and method according to yet another aspect of the present invention, specifically the elements and process of asset leveraged asset package market making, margin lending and clearing.

FIG. 5 depicts a block diagram illustrating the types of asset package orders that can be handled by the system and method of the present invention and the general sequence of execution of such orders according to still another aspect of the present invention.

FIG. 6 depicts a flow diagram defining an exemplary algorithm for the process of asset package price discovery with respect to buy or sell orders according to yet another aspect of the present invention.

FIG. 7 depicts a flow diagram defining an exemplary algorithm for the process of price discovery for asset package rollover orders according to still another aspect of the present invention.

FIG. 8 depicts a flow diagram defining an exemplary algorithm for the process of asset package order execution with respect to buy, sell or rollover orders according to yet another aspect of the present invention.

FIG. 9 depicts a flow diagram defining an exemplary algorithm for the process of price discovery for asset package break orders according to still another aspect of the present invention.

FIG. 10 depicts a flow diagram defining an exemplary algorithm for the process of price (credit) discovery with respect to trade-in-position-for-asset-package orders according to yet another aspect of the present invention.

FIG. 11 depicts a flow diagram defining an exemplary algorithm for the process of asset package order execution with respect to break or trade-in orders according to still another aspect of the present invention.

FIG. 12 depicts a block diagram illustrating the effects of different types of asset package orders processed by the system and method of the present invention on the debits and credits of asset package market maker's margin account with the margin lending facility.

FIG. 13 depicts a flow diagram of an exemplary embodiment of the central aspects of the system and method of the present invention, while illustrating the relationships between FIGS. 5 through 11.

FIG. 14 depicts a block diagram illustrating an exemplary embodiment of an Asset Package and the origin of its embedded leverage according to another aspect of the present invention.

FIG. 15 depicts a block diagram illustrating an exemplary embodiment of the leverage gain over conventional margin realized through asset package margin lending according to still another aspect of the present invention.

FIG. 16 depicts a block diagram illustrating an inefficient transfer of true market risk and hedgeable risk in conventional margin lending.

FIG. 17 depicts a block diagram illustrating an exemplary embodiment of an efficient transfer of true market risk and hedgeable risk in asset package market making combined with margin lending according to yet another aspect of the present invention.

### DETAILED DESCRIPTION

As used herein, assets, rights or liabilities refers to any tradable commodity or item of value in which there exists a market for trading. This definition includes securities, equities, derivatives, currencies, fungible commodities, insurance contracts, mortgages, real estate, bonds, time shares, airline reservations, hotel reservations, golf tee times, country club memberships, antiques, pollution rights, instruments, cash or cash equivalent instruments, synthetic positions, asset packages, etc. Although the computer-based system of the present invention can be used with regard to any asset or liability that is traded, the discussion herein relates primarily to its use in connection with securities for simplicity purposes.

Conventional trading in synthetic positions vs. trading of leveraged asset packages

Synthetic positions are frequently used by hedgers as a way of limiting risk while retaining the benefits of ownership of the underlying cash equivalent (e.g., an equity instrument). When acquiring, for example, a synthetic long call position, a trader would place a combination order with his/her broker, who then attempts to execute the separate leg orders leading to the desired position.

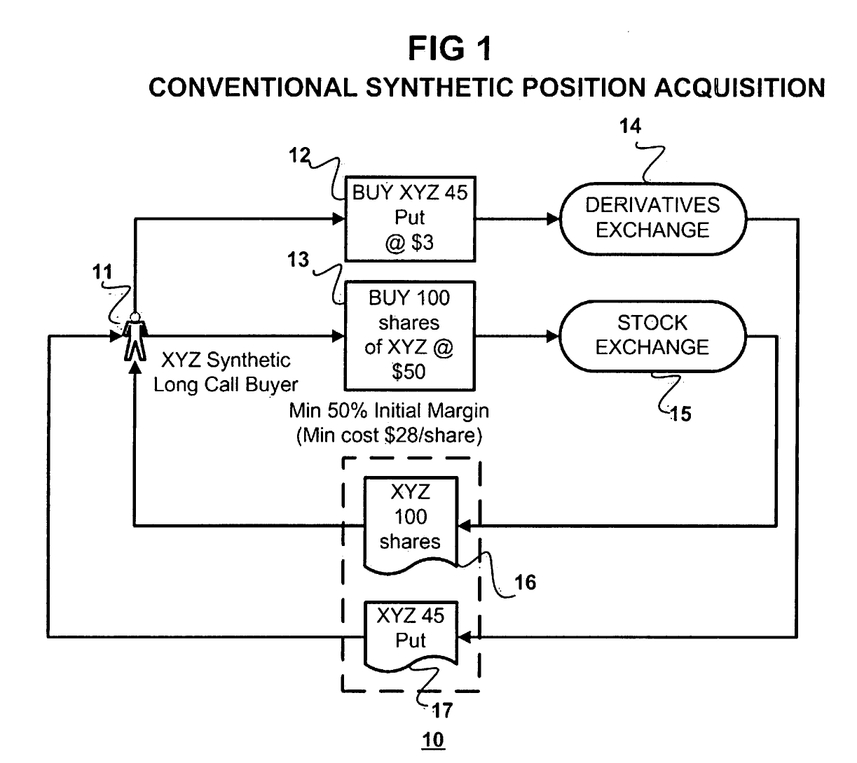

An example of a conventional order process 10 for purchasing a combined equity and derivative is depicted in FIG. 1. A trader 11 places an order 13 to buy 100 shares of XYZ, currently traded at $50 per share in the stock market 15 and an order 12 to buy one “(December) XYZ 45 Put” currently traded at $3 on a derivative or options exchange 14. Trader 11 is an XYZ synthetic long call buyer. In attempt to achieve maximum leverage on his/her investment the trader 11 buys the 100 shares of XYZ on margin. Subject to Regulation T, such a trade 13 requires an initial margin (deposit) of 50% of the stock's market value or $25 per share of XYZ. Because the option leg 12 of the order cannot be bought on margin, the total cost of the synthetic long call position is $28 ($25+$3), while a $25 debit balance is carried in the margin account for trader 11. Even though the actual market risk of the position is limited to $5 ($50−$45), the trader 11 has to deposit $25 per share in his margin account to make the trade. From the stock exchange 15 the trader 11 receives the equity portion 16 (the 100 shares of XYZ) and the derivative portion 17 (the one 45 Put of XYZ).

Thus, there is inefficiency in the conventional process for purchasing a combined equity and related derivative when purchasing the combined equity and the related derivative on margin. Moreover, this inefficiency is significant when leveraged purchases of combined equity and related derivatives are made in large numbers of shares. This inefficiency represents both a significant lost opportunity cost for the funds maintained in the margin account, as well as an inhibition on traders to make large leveraged purchases of combined equity and related derivatives. By forcing such traders to place this amount of funds in the margin account, the conventional process acts as a deterrent to such trades, when in fact these trades possess significantly reduced risk as compared to trades involving only the equity instruments.

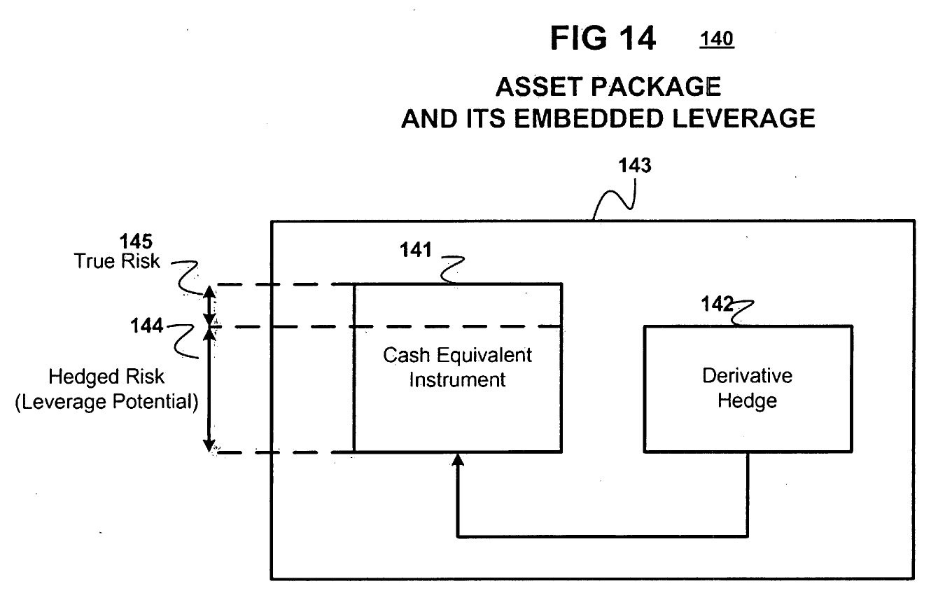

FIG. 14 illustrates an exemplary embodiment of an Asset Package and the origin of its embedded leverage. Here, element 141 is one or more cash or cash equivalent instruments (assets, rights or liabilities), hereinafter referred to as Cash Equivalent Instrument. Element 142 is one or more derivative instruments (assets, rights or liabilities) used as a hedge for cash equivalent instrument, hereinafter referred to as Derivative Hedge. Element 144 marks the level of protection (hedging) of cash equivalent instrument 141 from exposure to market risk by the derivative hedge. Asset Package 143 represents a combination (synthetic order) of cash equivalent instrument 141 and its derivative hedge 142. The fact that a portion 144 of the cash equivalent instrument 141 in the asset package 143 is covered from exposure to the market risk, allows this portion to be loaned to the trader at a virtually risk-free rate of interest when executing the trading contract (excluding the cost of the derivative hedge), which is the source of leverage embedded in the asset package 143. The definitions of cash equivalent, derivative hedge, and the level of protection (hedging) are generic and can be applied to various classes of assets, rights and liabilities in different market and trading systems according to various aspects of the present invention.

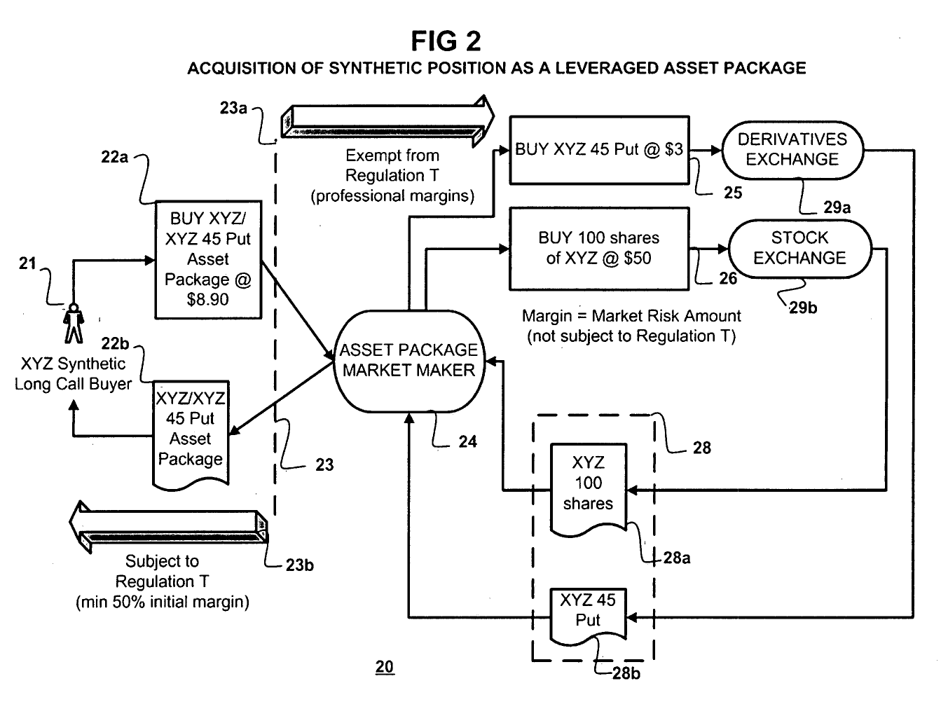

Turning to FIG. 2, shown therein is an exemplary embodiment 20 of a process for trading a combined equity instrument and a related derivative instrument, in this case a put position. In this exemplary embodiment, an asset package market maker 24 stands between the XYZ synthetic long call buyer 21 and the derivative exchange 29a and the stock exchange 29b to place the order 25 to purchase the put position 28b and to place the order 26 to purchase the related equity instrument 28a. The Asset Package Market Maker 24 (hereafter also referred to as APMM), in accordance with one aspect of the present invention, conducts a virtual dynamic securitization of synthetic long call position 28 (combined equity instrument 28a and put position 28b) into a discounted (leveraged) asset package 22b. Through being a registered broker-dealer and a member of the relevant Securities Regulated Organizations (SROs) the APMM 24 qualifies as an exempt trader for the purpose of Regulation T. Thus, those traders/organizations on the side of dashed line 23 in the direction of arrow 23b are subject to Regulation T and therefore must place 50% on margin, whereas those on the side of dashed line 23 in the direction of arrow 23a are exempt from Regulation T and need not meet the 50% margin requirement. Thus, by separating the function of the combining the equity instrument and put position, i.e., securitization, from the purchasing of the combined equity instrument and put position by a non-professional trader, the present invention removes the inefficiencies mentioned above.

As the APMM 24 exists on the side of dashed line 23 by virtue of its membership in the relevant Securities Regulating Organizations (SROs) and being a registered broker-dealer, this implies that trades of the Asset Package Market Maker 24 executed on credit are not subject to Regulation T's margin requirements. By projecting the demand for synthetic positions, APMM 24 is able to quote the asset package prices and offer them to his/her market in discounted form. If an order 22a for such a package 22b is received, the APMM 24 executes it on margin while the retail customer 21 purchases an already leveraged instrument in compliance with the Regulation T.

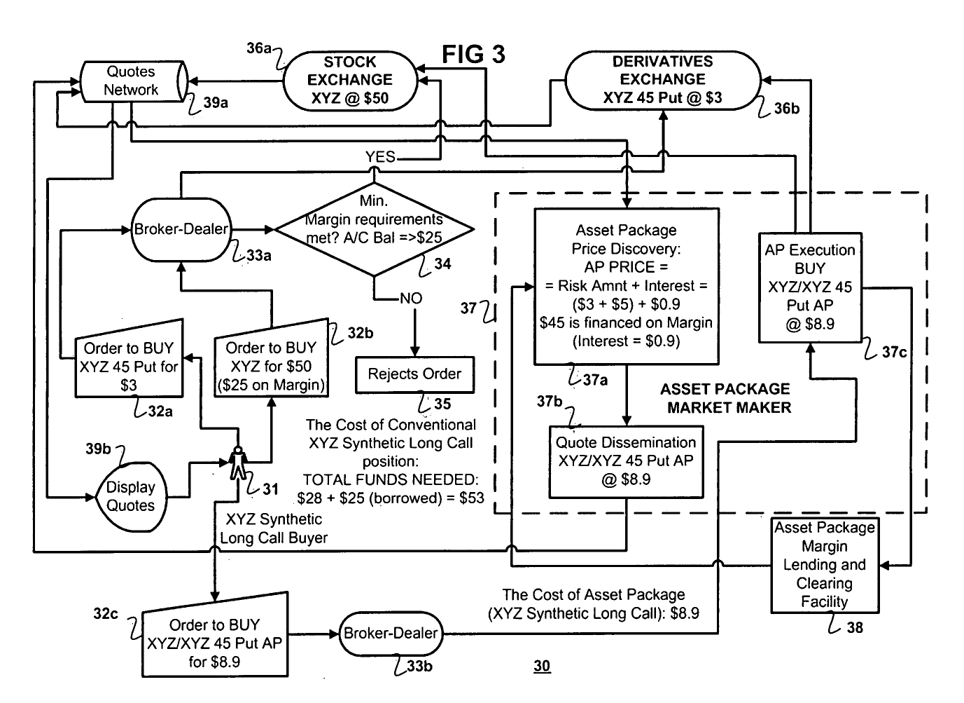

FIG. 2 illustrates the process of generating leverage in trading of a synthetic long call position as an asset package. APMM 24 receives an order 22a for a synthetic long call asset package 22b quoted at $8.9 per packaged share. This price ($8.90) includes the unprotected cost component of the position (UCC), which is the sum of: (1) the difference between the price per share of XYZ and the strike of the XYZ put ($50−$45=$5); (2) cost of XYZ put (option premium: $3); and (3) the margin interest component, e.g., $0.9, that covers the cost of interest of the margin facility of the APMM 24 until the expiration date of the asset package's put contract. The APMM 24 executes the trade and the buyer 21 receives the trade confirmation for an asset package 22b bought at $8.90 per share—a significance savings over the $28.00 per share of the conventional approach. Since the orders 25, 26 for the legs 28a, 28b have been leveraged through a centralized margin lending and clearing facility (hereafter also referred to as APMLCF) 38 (see FIG. 3) of the APMM 24 prior to price discovery of the asset package 22b, the order for the combined asset put package 22a is not executed on margin by the trader 21 and therefore represents leverage in compliance with Regulation T. In this continuing example, the savings of $28.00 less the $8.90, which equals $19.10. This $19.10 quantifies the inefficiency in the conventional process in the continuing example. The actual amount will vary with each order and put combination depending on the cost of the interest and the relative put price and equity instrument price. The actual value of the inefficiency will be governed by the following equation:
i. Inefficiency=(mP_{E}+P_{O})−P_{E+O} Equation 1

where P_{E} represents the price of the equity portion, P_{O} represents the price of the option portion and P_{E+O} represents the price of the combined equity and option asset package. The factor m represents the margin requirement, which in this example is ½ or 50%.
i. P_{E+O}=(P_{E}−S_{O})+P_{O}+I Equation 2

where S_{O} represents the strike of the option portion of the asset package and I represents the interest charged by the APMM 24. Substituting Equation 2 into Equation 1 results in:
i. Inefficiency=S_{O}−(1−m)P_{E}−I Equation 3

Thus, the inefficiency savings resulting from use of the method of the present invention will be large as the strike value approaches the price of the equity leg, and in this example will be bounded by:

$$i . Inefficiency < \frac{{P}_{E}}{2}$$

as S_{O} can never exceed P_{E} for this example and I is typically small relative to P_{E} and m is typically ½. Thus, for high priced equities, the methods of the present invention will provide significant savings, especially for large purchases. Of course, the savings is offset by a margin debt incurred.

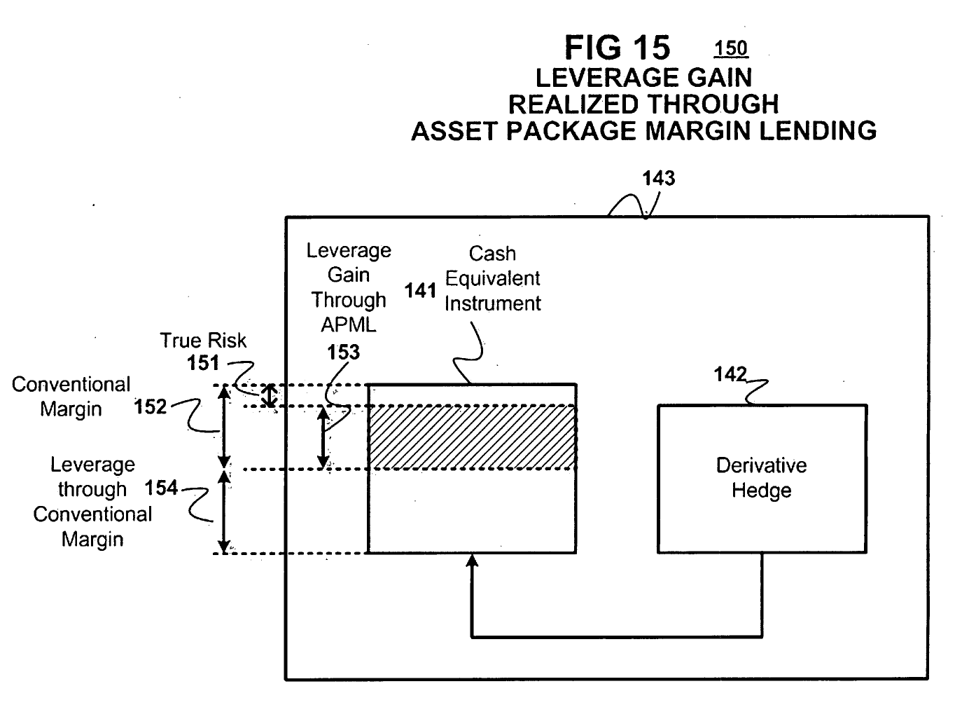

FIG. 15 illustrates a generic representation of the leverage inefficiency described above for the margin requirement of 50% applied to margin lending for cash equivalent instruments. Leverage 154 that can be gained by conventional trading on margin equals the difference between the cost of the cash equivalent 141 and the cash equivalent's required (conventional) margin amount 152 (excluding the cost of derivative hedge instrument). The asset package's embedded leverage exceeds such conventional leverage by the difference 153 between the hedgeable risk 144 (as shown on FIG. 14) provided by derivative hedge instrument 142 and the leverage 154 gained through conventional margin 152. This amount 153 represents inefficiency described above and the leverage gain realized through asset package margin lending (APML). The true market risk amount 151 cannot be leveraged and has to be paid in cash.

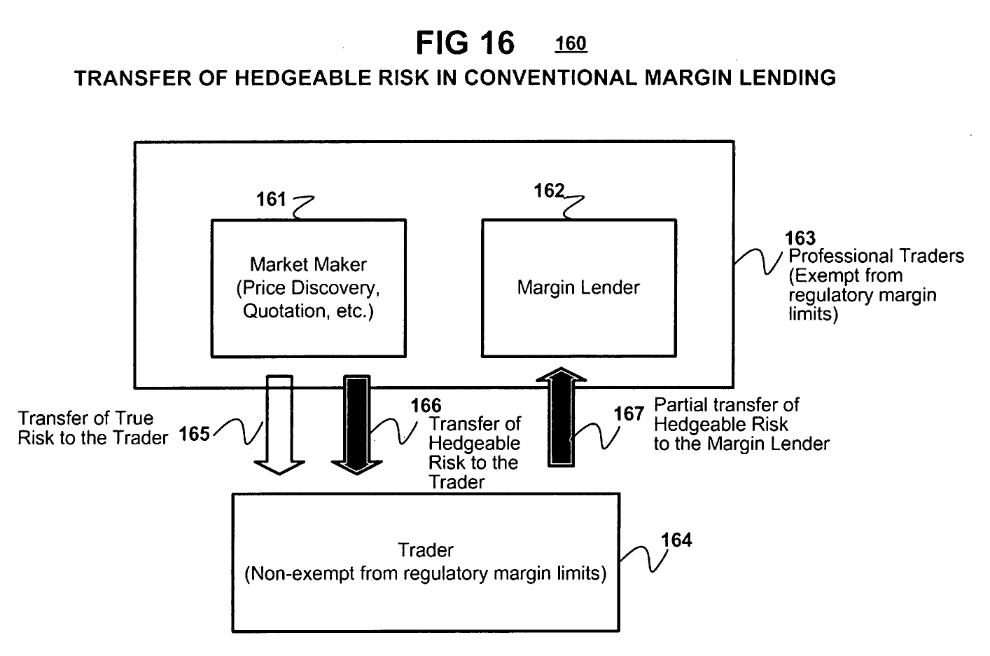

FIG. 16 describes transfer of market risk between market maker 161, trader 164 and the margin lender 162. The true market risk 165 and hedgeable risk 166 are transferred to trader 164 by the market maker. The trader has an option to transfer hedgeable risk to the margin lender. The market maker and margin lender are professional traders 163 and are conventionally exempt from the regulatory margin limits (such as Regulation T). The trader 164, however, is not a professional trader, and is not exempt from such limits. Therefore, the amount of hedgeable risk 167 that can be transferred back to the exempt margin lender 162 is restricted by such regulatory limits, which results in a partial (inefficient) risk transfer. The transfer is also partial due to the fact that not all traders will realize this risk transfer option and some hedgeable risk will continue to be carried by such traders. This illustrates the inefficiency of pricing and hedgeable risk transfer in conventional trading on margin.

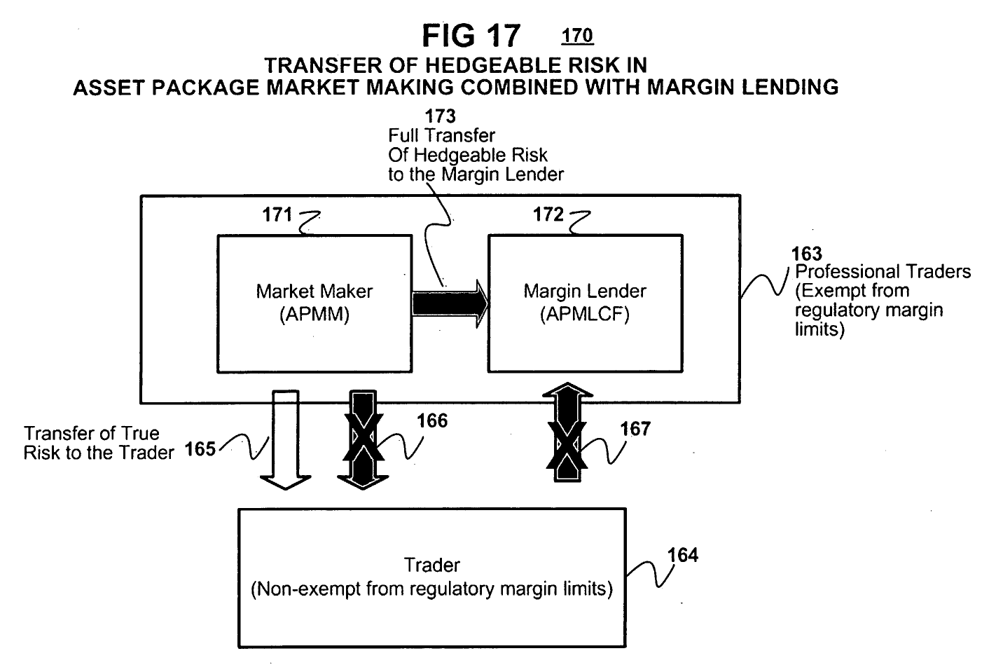

FIG. 17 describes the effect of combining margin lending and market making into one process on gaining maximum efficiency in leverage and transfer of risk. The Asset Package Market Maker 171 fully transfers the hedgeable risk 173 to the APMLCF 172 (margin lender) before the asset package is even traded. This accomplishes maximum leverage gain and pricing efficiency. The inefficient and partial transfers of hedgeable risk to the trader 166 and from the trader to margin lender 167 are eliminated. This mechanism provides maximum leverage gains to all asset package traders without promoting speculation or imposing any additional risk on the trader. On the opposite, the risk carried by the trader is reduced due to transfer of hedgeable risk to margin lender before trading occurs.

Turning to FIG. 3, shown therein is an exemplary embodiment 30 of an apparatus for implementing the methods of the present invention employing the original example of FIGS. 1-2. Here, the trader 31 acquiring a synthetic long call has two choices. One is a conventional execution of a combination order represented by orders 32a, 32b, without guarantee of target price or order filling and subject to Regulation T's margin requirements. The total cost to the trader 31 is $28 plus the cost of $25 in margin debt per share of XYZ. If the quoted order 32c of the APMM 37 is executed instead the cost to trader 31 is $8.90 per packaged share of XYZ, while $45 debt per share is carried by the APMLCF 38 for $0.90 per share interest. In the latter case, the cost of debt is included, whereas in the former case the cost of the $25 margin debt is not quantified, but exists nonetheless. When determining the true cost savings resulting from the methods of the present invention, the $19.10 per share cost savings calculated above should be increased by the cost of the $25 per share margin debt carried in the conventional approach. Thus, for a 100-share purchase, the synthetic long call buyer 31 of a married put pays $2800 plus the cost of $2500 margin debt in the conventional approach, whereas the same buyer 31 pays only $890 out of pocket using the methods of the present invention. Of course, in the latter case the buyer 31 still owes $4500 of debt, but the interest cost of this debt is prepaid, whereas the interest cost of the $2500 margin debt resulting from the conventional approach must still be paid.

Shown in FIG. 3, are elements 37a-c of the APMM 37, which together with the Asset Package Margin Lending and Clearing Facility 38 represent exemplary embodiments of the apparatus and method of the present invention.

The system 30 depicted in FIG. 3 operates as follows. A synthetic long call buyer 31 receives quotes from a quotes network 39a via display 39b, which displays both the quotes for the individual legs 32a, 32b as well as the asset package 32c. The quotes network receives inputs from the stock exchange 36a, the derivative exchange 36b, as well as the Quote Dissemination Module 37b in the Asset Package Market Maker 37.

In the conventional approach, the synthetic long call buyer 31 would place two orders 32a, 32b to purchase the individual legs of the combination via a broker-dealer 33a. The broker-dealer 33a would then check to determine if the minimum margin requirements were met in decision element 34 as part of the leveraged purchase of the equity leg. If not, the broker-dealer 33a would reject the order 35, but the derivative order may still be placed. If so, the equity order 32a would be sent to the stock exchange 36a. Since the derivative order 32b cannot be purchased on margin, the derivative order 32b would be sent to the derivative exchange directly—even if the equity order 32a was ultimately rejected due to insufficient margin.

Alternatively, the synthetic long call buyer 31 could place an order 32c to buy the combined asset package via a broker-dealer 33b (which may or may not be the same as 33a), which in turn places the order with the Asset Package Market Maker 37. The combined order 32c is executed by the Asset Package Execution Module 37c within the Asset Package Market Maker 37, which Asset Package Execution Module 37c performs the buys of the individual legs on the stock exchange 36a and the derivative exchange 36b. The execution is reported by the Asset Package Execution Module 37c to the Asset Package Margin Lending and Clearing Facility 38. The Asset Package Price Discovery Module 37a receives quotes from the Quotes Network 39a and prepares quotes on the combined asset package and sends them to the Quote Dissemination Module 37b for distribution to the Quotes Network 39a. The Asset Package Price Discovery Module 37a also receives output from the Asset Package Margin Lending and Clearing Facility 38 for use in preparing quotes of the combined asset packages.

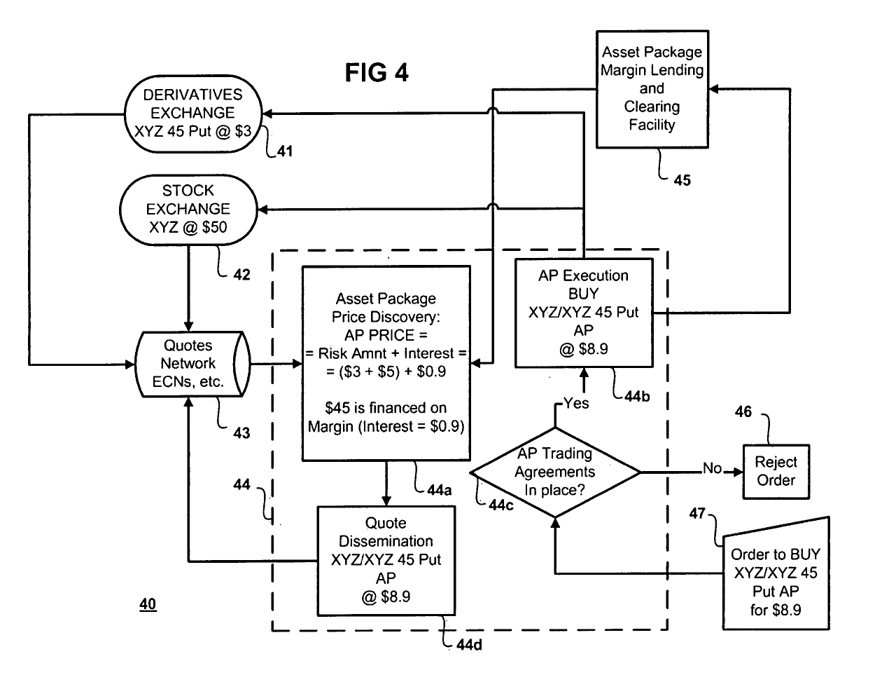

Turning to FIG. 4, shown therein is another exemplary embodiment 40 of the present invention, which shows in particular the Asset Package Market Maker 44 and its interaction with the various other systems involved in trading securities, such as the Quotes Network 43, the stock exchange 42 and the derivative exchange 41. In addition, the interaction of the APMM 44 and the Asset Package Margin Lending and Clearing Facility 45 is depicted.

FIG. 4 depicts the main modules of the APMM 37. These main modules include: (1) Asset Package Price Discovery Module 44a; (2) Quote Dissemination Module 44d; (3) Asset Package Order Execution Module 44b; and (4) Asset Package Trading Agreements Qualification Module 44c. Also a part of the exemplary embodiment is the Asset Package Margin Lending and Clearing Facility 45.

The Asset Package Price Discovery Module 44a continuously collects quotes from the underlying markets and, potentially, other APMMs 44, for the defined asset packages as well as current interest rates and collateral qualifications data from the Asset Package Margin Lending and Clearing Facility 45. Then through its price discovery algorithms this module 44a generates a series of asset package quotes classified by order type, etc. The resulting stream of quotes is broadcast by Quote Dissemination Module 44d to the Quotes network 43, which includes ECNs, exchanges and other quotation systems. If in response to such broadcasted quotations, an order is submitted for an asset package execution, the order 47 is then received by the Asset Package Trading Agreements Qualification Module 44c. This module 44c goes through a list of automatic checks for compliance with the asset package specific trading agreements between APMM 44 and the customer's brokerage (not shown). Such escrow agreements establish an asset package's status as a virtual security and guarantee that the leg order securities will not be sold separately as long as the asset package exists. If qualification of the asset package agreements cannot be achieved the order will be rejected at this point, followed by a note 46 regarding a missing agreement to the client's broker. If the qualifications are in place, the order is forwarded to Asset Package Order Execution Module 44b.

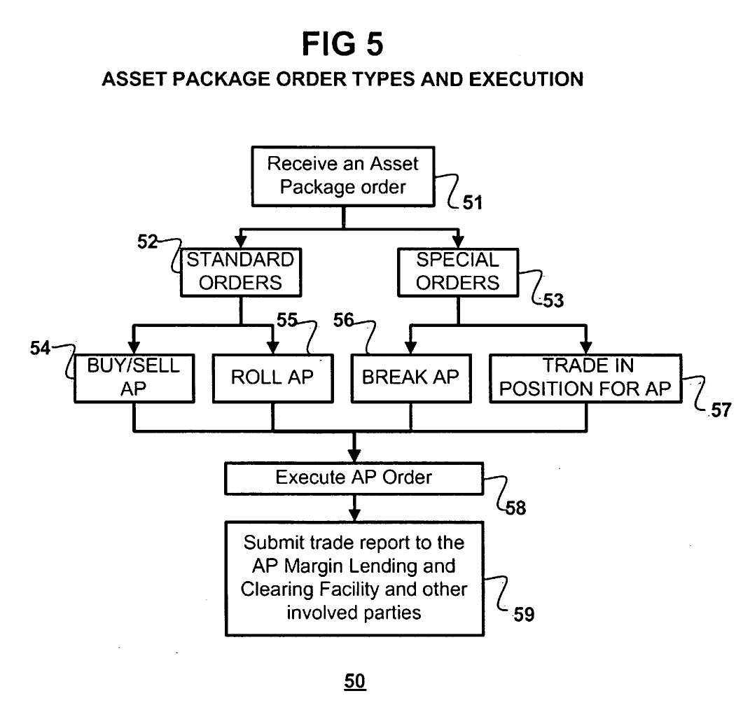

Depending on the type of submitted order the Asset Package Order Execution Module 44b follows the appropriate execution algorithm and if required executes the necessary leg orders in the underlying markets partly using the funds from APMM's 44 account with the Asset Package Margin Lending and Clearing Facility 45. Upon execution the Asset Package Order Execution Module 44b generates a trade report that is then forwarded to the clearing brokers in the underlying markets, the client's broker and the Asset Package Margin Lending and Clearing Facility 45, which in turn manages the process of trade clearing with all involved parties, settlement and disposition of the asset package following its sale, expiration or termination through a break order 56 (as shown on FIG. 5).

Turning to FIG. 5, shown therein is an exemplary embodiment 50 of a process for processing asset packages. Defined in FIG. 5 are types of asset package orders handled by the method and apparatus of the present invention. In step 51, the apparatus of the present invention receives an order for an asset package. This order can include two types of orders—Standard Orders 52 (those emulating the trading orders utilized in conventional synthetic positions trading) and Special Orders 53, of which there are two types: an Asset Package Break Order 56 and a Trade-in-Position-for-Asset Package Order 57. FIG. 5 also depicts the general sequence of events in an asset package order execution process. Buy and Sell orders 54 (which are part of the Standard Orders 52) capacity constitutes one aspect of functionality of the apparatus and method of the present invention.

Special Orders 53 provide the customers of the entity employing the apparatus and method of the present invention with such novel features as ability to roll a synthetic position over with a click of a button (i.e., Roll AP 55), as well as to extract funds out of a currently held synthetic (hedged) position by trading such position in exchange for a relevant asset package and a credit disbursement (i.e., Trade-In Position for AP 57). After the specific order is processed (elements 54-57), the asset package order is executed (step 58) and a trade report is submitted to the APMLCF and other involved parties (step 59).

The price discovery algorithm described below for asset package rollover orders allows the APMM to quote single price (net) rollover scenarios for a plurality of synthetic positions based on various cash instruments, expiration months and strikes. Introduction of the Trade-In order establishes a way for the APMLCF to tap into a substantial pool of underleveraged funds tied up in the hedged synthetic positions. Extracting such funds and rerouting them back to traders will stimulate growth in trading activity and result in overall increase in markets liquidity.

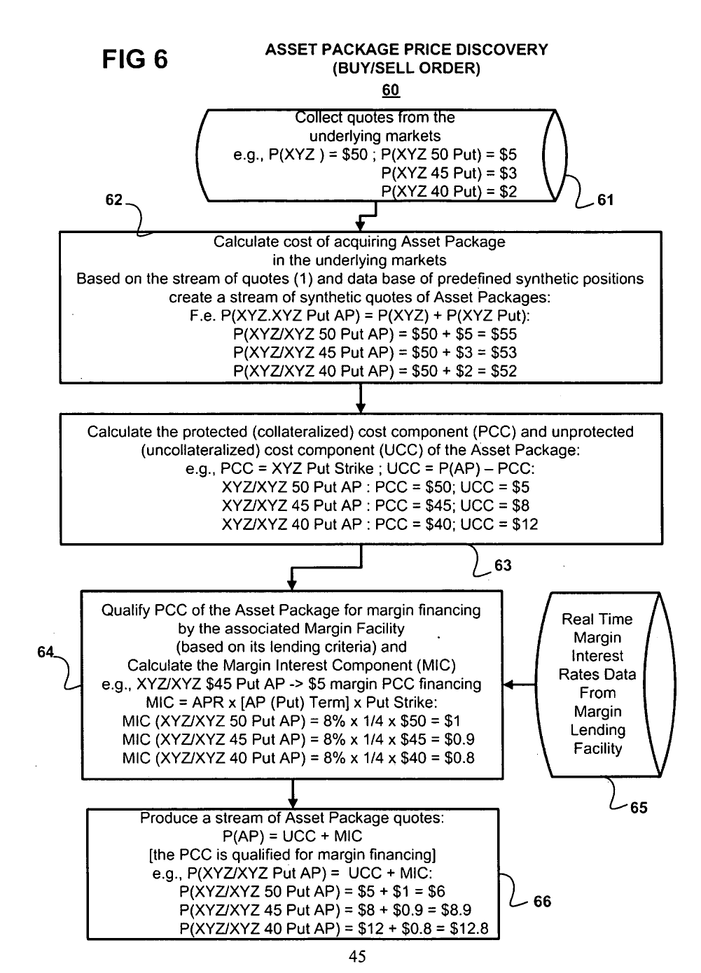

FIGS. 6 through 10 describe exemplary embodiments of algorithms of price discovery and execution of defined order types by the apparatus and method of the present invention.

Turning to FIG. 6, shown therein is an exemplary flow diagram 60 for the algorithm of price discovery for asset package buy and sell trade orders.

In step 61, quotes for the underlying cash equivalent security and its derivative (such as a put option) are collected from quotation networks (such as Electronic Communication Networks) and, potentially, other APMMs. Using the example described in FIGS. 1 through 4, the current market price (best ask price) of XYZ stock is $50 and its put options are quoted at $5, $3 and $2 for options with $50, $45 and $40 strikes, respectively.

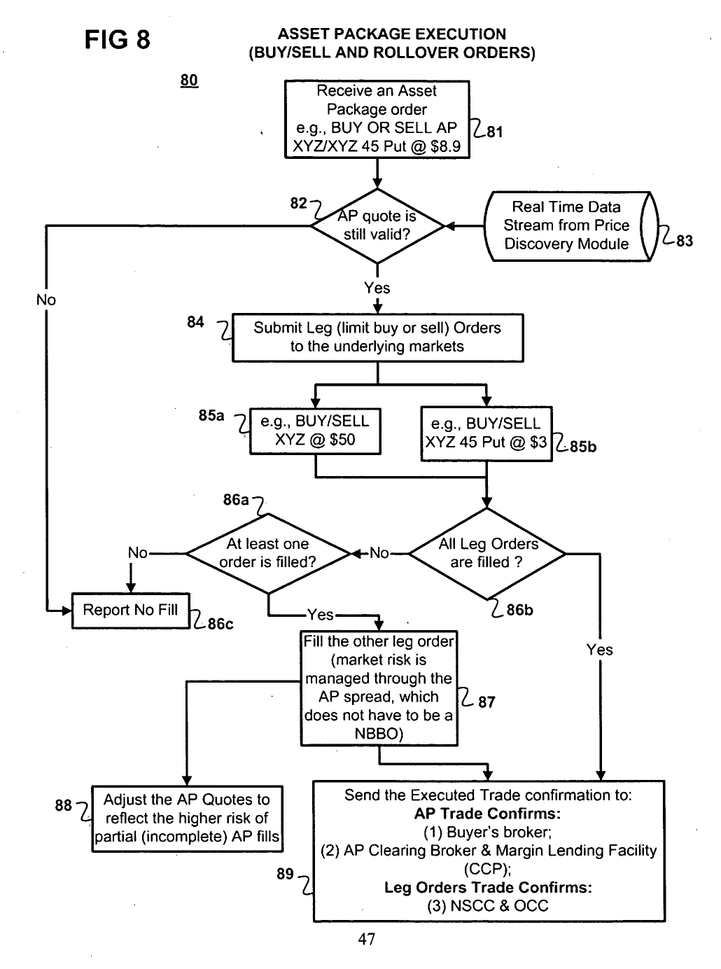

In step 62, the current cost of acquiring the asset package in the underlying (equity and derivative) markets is calculated. The total cost of acquiring asset package in the current example will be $55, $53 and $52 for the three described combinations of XYZ and put options with different strikes. It is important to note, that the total calculated costs of asset packages may include APMM's spread component that is based on the sum of the national best bid and offer (NBBO) for the leg orders and APMM's risk of not being able to fill both leg orders comprising the asset package. The origin of this spread component is further described in the execution algorithm for buy, sell and rollover orders (see FIG. 8).

In step 63, the protected (or collateralized) cost component (PCC) and the unprotected (uncollateralized) cost component (UCC) of the asset package are calculated. The PCC defines the portion of the asset package's cost that can be financed on margin by the Asset Package Margin and Clearing Facility. In the current example, PCC equals the strike price of the put option leg of the asset package ($50, $45, and $40, in the current example). The UCC is calculated as a difference between cost of the Asset Package [P(AP)] and the PCC, which represents the portion of the asset package cost exposed to market risk ($5, $8, and $12 in the current example).

In step 64, the PCC of the asset package is qualified for financing on margin by the Asset Package Margin and Clearing Facility and the margin interest component (MIC) is calculated. Because the asset package is hedged up to the PCC level, the PCC represents the maximum available level of financing for the package. The MIC is calculated based on the current margin interest rates data stream provided by the Asset Package Margin and Clearing Facility (from step 65) and the asset package's (put option's) time till expiration. In the current example, the margin financing APR is 8%. If the time till expiration for the package's option is 3 months then the MIC values for the asset packages with three strikes used in the current example will be $1.00, $0.90, and $0.88, respectively.

In step 66, the final quote for the asset package is assembled. The quoted price of the package is calculated as the sum of UCC and MIC components calculated in steps 63 and 64. This means that the cost of margin financing interest is charged upfront and is embedded in the asset package quote before it's even traded. In the current example, the three quoted asset package prices (best ask prices) will be quoted as $6, $8.9, and $12.8, respectively. Alternative methods to charging MIC upfront can be devised for calculating and charging the margin interest for the package. The final asset package quotes are then broadcast into the quotations networks (ECNs, etc.) for dissemination throughout the markets.

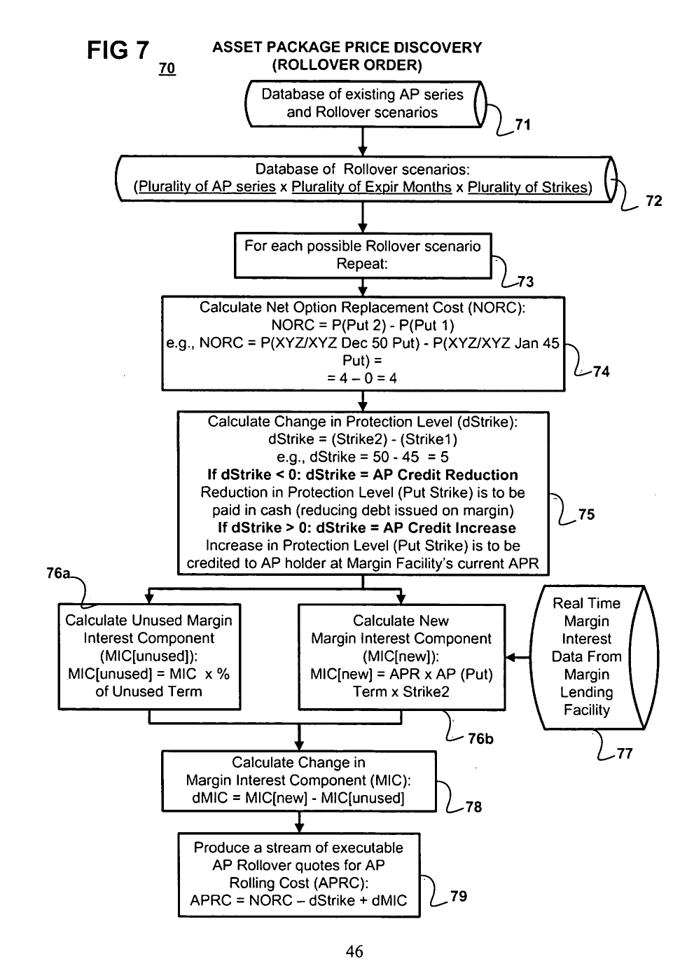

Turning to FIG. 7, shown therein is an exemplary flow diagram 70 for the algorithm of price discovery for asset package rollover trade orders. Asset package rollover orders, essentially, mean replacement of the option (put) leg of the package, such as in case of approaching expiration. Asset packages can be rolled either up (when the strike of the new option leg is higher), down, (when the new put's strike is lower than the original's) or out (when the strikes are equal).

Based on the database 71 of existing asset package series (packages that are quoted or have been traded) and the database 72 of possible rollover scenarios, which includes all put options series that could be potentially used in asset package rollovers, the main body of the algorithm is performed for each of the generated rollover scenarios, as shown in step 73.

In step 74 of the algorithm 70 Net Option Replacement Cost (NORC) is calculated as a difference between the new asset package's put premium and the current market value of the original option. In case of a rollover of an asset package with the put strike price of $45 to a package with a $50 strike put, where the current package put option's value is approximately zero (due to approaching expiration date) and the new put option's premium is $4, the NORC equals $4 ($4−0).

In step 75, a change in Protection Level (dStrike) is calculated as a difference between the new put's and the original put option's strike prices. If dStrike is less than zero then the Protection Level is decreased and is to be added to the cost of the rollover order. This portion of the rollover order will be paid in cash to the Asset Package Margin Lending and Clearing Facility, which will reduce the asset package debt issued on margin. If dStrike is higher than zero than the Protection Level is increased and will be credited to asset package holder by the APMLCF at its current interest rate.

In the current example dStrike is equal to $5 ($50−$45). That means that $5 will be credited to asset package holder's account after margin interest deduction and the necessary adjustments made in other blocks of the algorithm.

In step 76b, based on the real time margin interest data stream from the APMLCF, the New Margin Interest Component MIC[new] is calculated as a product of the current margin interest (APR), number of days till expiration of the new put option, and its strike price (Strike2).

In parallel in step 76a, the Unused Margin Interest Component MIC[Unused] is calculated as a percentage of the original MIC, which hasn't been fully applied (in case of rolling prior to expiration of the asset package).

In step 78, the Change in Margin Interest Component (dMIC) is calculated as a difference between MIC[new] and MIC[unused]. This amount represents the adjusted margin interest component for the rolled asset package.

Finally, in step 79 a stream of quotes is produced for Asset Package Rolling Costs (APRC), where APRC is calculated as NORC−dStrike+dMIC. Thus the main components of the rolling cost for a package include the Net Option Replacement Cost, debit or credit to asset package holder's margin with the APMLCF and the change in Margin Interest Component due to rollover.

FIG. 8 illustrates an exemplary order execution algorithm 80 for Buy, Sell and Rollover (standard) orders. A standard order from a trader is submitted by his/her brokerage firm and received by the APMM 81 (i.e., a buy order is received for an asset package, which includes XYZ shares contract and a $45 put contract for $8.9 per asset package contract. This quote includes the margin interest cost as well).

Based on the real time data stream from the Price Discovery Module 83, the received order is verified for availability on the market in element 82. If the quote is no longer valid (in case one or both leg quotes moved away from the original quote) than the order is rejected and a ‘No fill’ report is generated and transmitted to the trader's brokerage in element 86c.

If the quote is still valid than the order is submitted for execution in the underlying markets (leg markets) in element 84. Based on the current example, in this process two orders are generated: one order 85a on the relevant stock exchange and one order 85b on the relevant options exchange based on their ability to fill the leg orders at the designated price levels.

Upon submission of the leg orders, element 86b of the algorithm validates if both leg orders have been executed based on the trade confirmation reports from the executing brokers in the leg markets. If both leg orders have been executed than the asset package execution has been completed at this point and the necessary trade confirmations are generated and transmitted in element 89. Particularly, trade confirmation reports are to be submitted to: (1) trader's brokerage firm; (2) APMLCF which acts as asset package clearing broker and margin lending facility at the same time, thus being a Central Counter Party (CCP) in all asset package transactions; (3) Leg order trade confirmations to the NSCC and OCC (for clearing of the package component securities in the leg markets).

In case not all leg orders have been filled element 86a takes over and verifies if at least one leg order has been filled. If none of the leg orders have been filled then a ‘No fill’ report is generated 86c and is transmitted to the trader's brokerage. If at least one leg order has been filled then the whole package order is completed at APMM's risk by filling the remaining leg order at the best market price in element 87. Upon execution of the remaining leg orders for the package the necessary trade confirmations are generated and transmitted in element 89 (as described above).

In parallel, a necessary adjustment for the risk of not being able to fill all leg orders at the quoted prices is incorporated into the APMM market spread by element 88. That means that the asset package quotes generated by the APMM's price discovery mechanism are continuously monitored and adjusted for such risk by the APMM. Thus, the asset package quoted market spread (net of the embedded leverage adjustment) may be wider than the spread based on the NBBO quotes from the leg markets. This spread component, however, is a necessary cost of APMM's ability to execute asset package orders when dealing with partial (incomplete package) fills.

The same description of the algorithm applies to execution of sell and rollover orders with order specific variables adjustment (such as price, etc.).

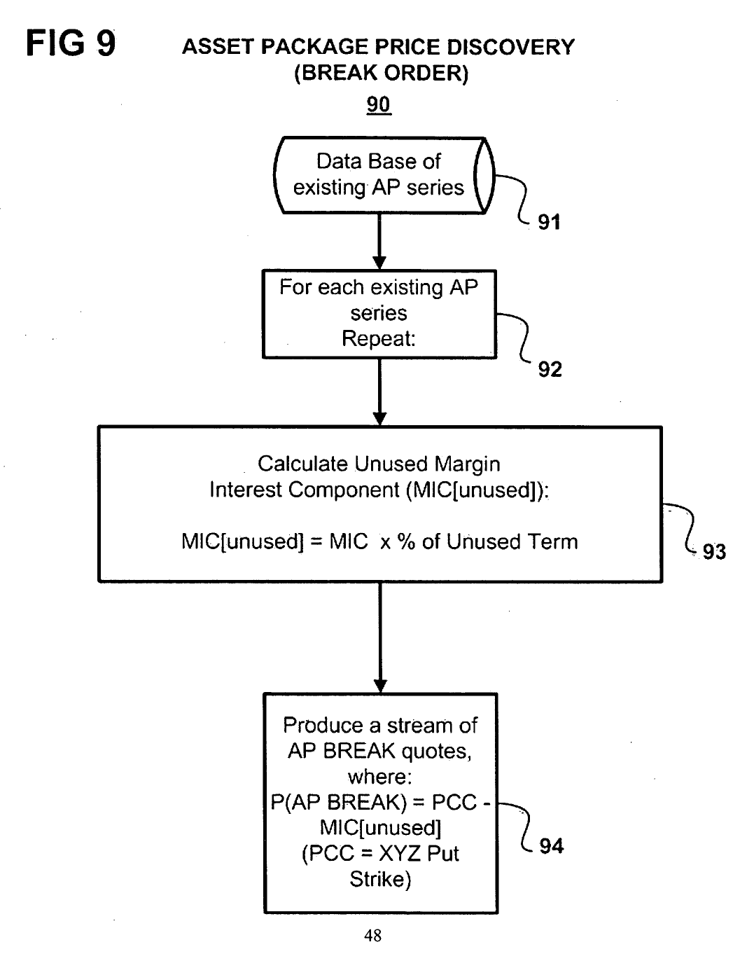

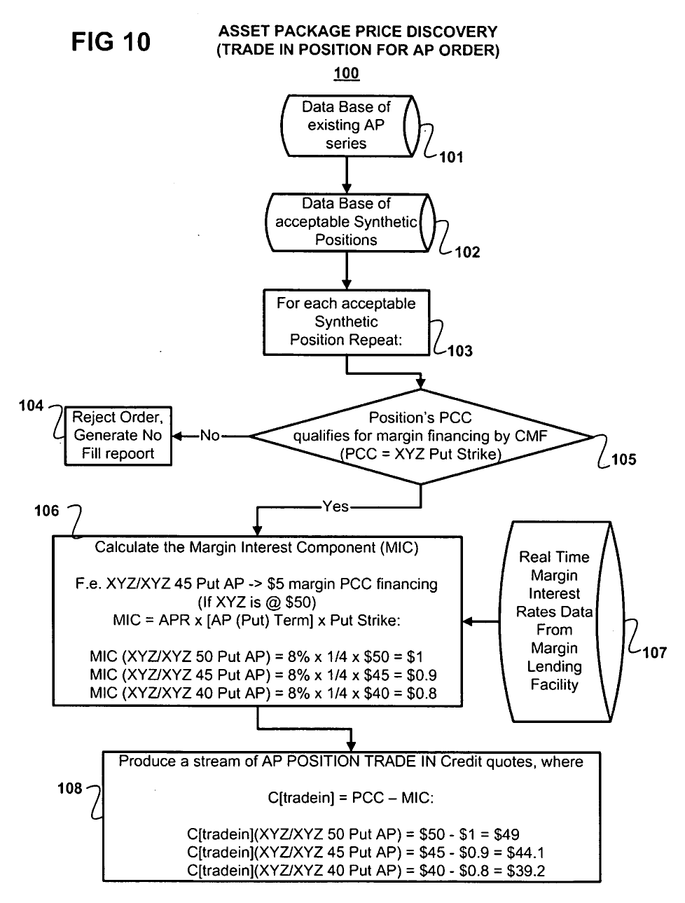

FIGS. 9 and 10 describe the price discovery of the special types of asset package orders: Asset Package Break order (FIG. 9) and Trade-In order (FIG. 10).

FIG. 9 illustrates an exemplary algorithm 90 of price discovery for Asset Package Break orders. Break order is executed either when an asset package holder wants to exchange the package for the underlying position (at the expense of paying off the margin debt) or it is automatically generated by the trader's brokerage when a package holder is looking to liquidate one of the legs of the package.

Based on the database 91 of the existing asset package series, a sequence of steps is repeated for each acceptable synthetic position by element 92.

In step 93, the Unused margin Interest Component (MIC[unused]) is calculated as a product of the original Asset Package MIC (charged when the package was originally bought) and the percentage of the remaining time till expiration in the maximum duration of the package.

In step 94, a stream of Break order quotes is generated, where the price of break order is calculated as a difference between PCC of the asset package (strike price of the put option) and the MIC[unused] as calculated in step 93.

FIG. 10 illustrates an exemplary algorithm 100 of price discovery for Trade-In Position for asset package (trade-in) orders.

Based on the database 101 of the existing asset package series, a database of acceptable synthetic (hedged) positions is generated in step 102. Based on this database a sequence of steps is repeated for each acceptable synthetic position by element 103.

In element 105, an acceptable synthetic position's PCC (protected cost component that is mostly equivalent to the position's put option's strike price) is qualified for margin financing by the APMLCF. This process is conducted based on the APMLCF's current lending criteria.

If the position does not qualify for margin financing than the order is rejected and a ‘No fill’ report is generated and transmitted to the trader's brokerage firm in element 104.

If the position's PCC qualifies for margin financing, then the margin Interest Component (MIC) of the Trade-In package is calculated in step 106 based on real time margin interest data stream from the APMLCF107. E.g., at 8% margin interest APR and 3 months till expiration positions hedged by puts struck at $50, $45, and $40 will have MIC at $1, $0.9, and $0.8 respectively.

In element 108 a stream of Trade-In (credit) quotes is generated, where the amount to be credited to the trader's account (Credit[tradein]) is calculated as a difference between PCC of the position and the MIC calculated in element 106. Based on the put strikes used in the current example, the Credit[tradein] quotes generated will be $49, $44.1, and $39.2 respectively. The quotes stream is then transmitted (fed) into the quotations networks for dissemination in the markets.

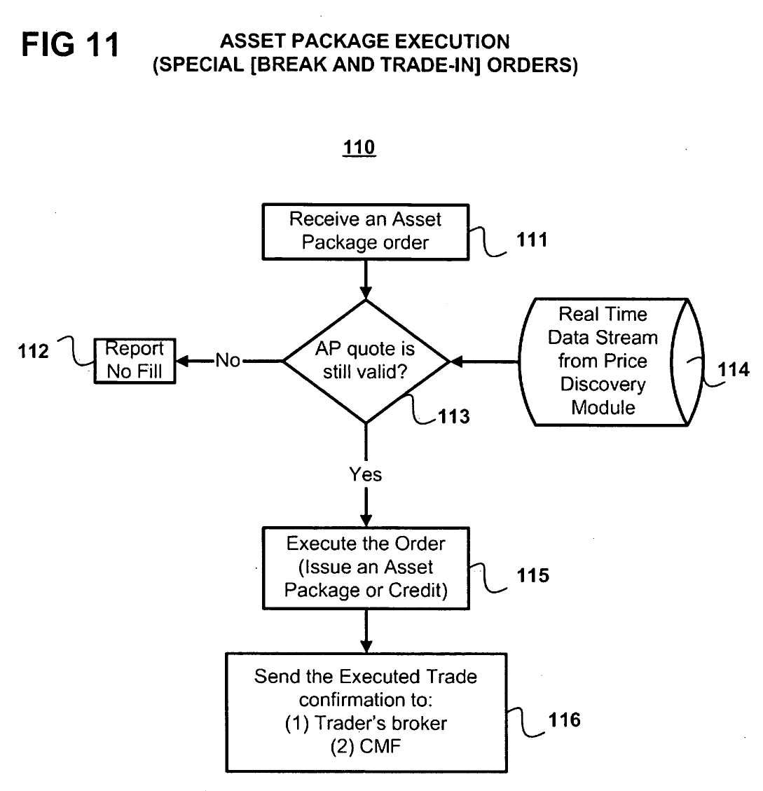

FIG. 11 illustrates execution algorithm for special (break and trade-in) asset package orders.

This execution algorithm is a simplified (collapsed) version of the execution algorithm for standard types of asset package orders (see FIG. 8).

Upon receiving a special asset package order in element 111, it is verified against the real time data stream from price discovery module 114 by element 113. If the quote is no longer valid (such as due to instantaneous change in margin interest rates, etc.) than the order is rejected and a ‘No fill’ report is generated and submitted to the trader's brokerage in element 112.

In case the quote on which the order is based is still valid, the order is executed in element 115 of the algorithm. In case of a Break order the underlying position is issued into the trader's brokerage account (the underlying position is transferred from the APMLCF to the trader in exchange for paying off the margin debt). In case of a Trade-In order, an asset package is issued into the trader's account based on the quoted Credit amount.

Upon execution of the special orders a trade report is generated and transmitted to the trader's brokerage in element 116 as well as to the APMLCF for clearing and settlement purposes.

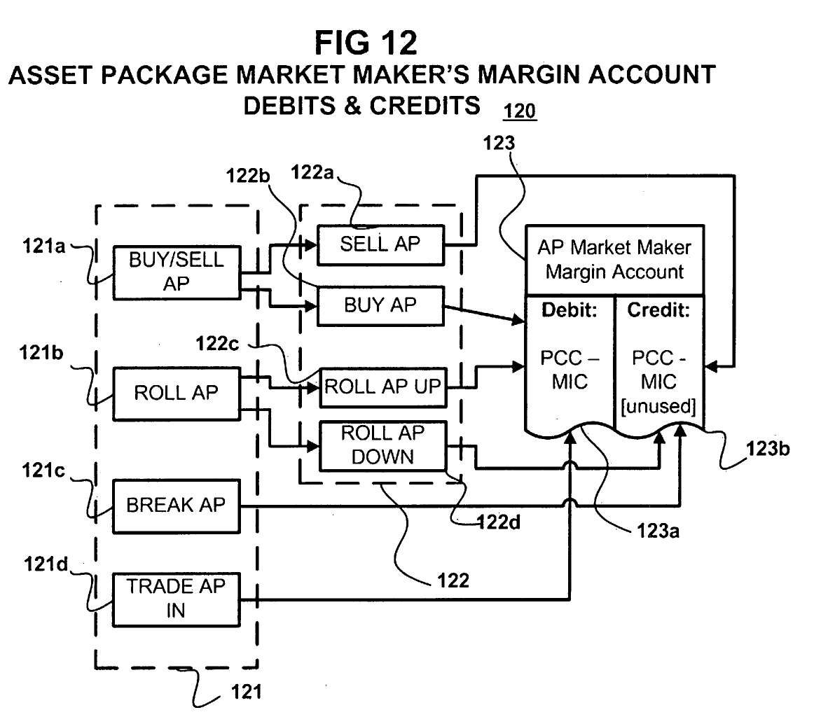

Turning to FIG. 12, shown therein is an exemplary flow diagram 120 of various orders and their impact on the margin account 123 of the APMLCF. Element 121a is the starting point for buy/sell asset packages. As shown, execution of a Buy order 122b creates a debit 123a in the APMM's margin account 123, creating a new asset package record in APMLCF's clearing database. Execution of a Sell order 122a releases such record creating a credit 123b in the APMM's margin account 123. The profits of the APMLCF are generated through accumulation of the risk free Margin Interest Component (MIC), which is reduced by MIC[unused] credit every time an asset package is sold or terminated as a result of Break AP order.

The effect of Rollover orders 121b on the market maker's margin account depends on the direction of the rollover. If the order results in replacement of a lower strike option leg by a higher strike one, such order will be rolling asset package up 122c and will result in a debit 123a to APMM's margin account 123. On the opposite, reducing the option's strike (protection level) will necessitate a payoff of the asset package credit, now exposed to the market risk (an AP roll-down 122d), and upon receipt of such payment will generate a credit 123b in the margin account 123.

A Break AP order 121c produces credits 123b in the APMM's margin account 123 as it requires a payoff of the borrowed asset package funds.

A Trade-In order 121d is, essentially, a credit disbursement to the hedged synthetic position holder in exchange for margin interest. It therefore, results in a debit 123a to the market maker's margin account 123.

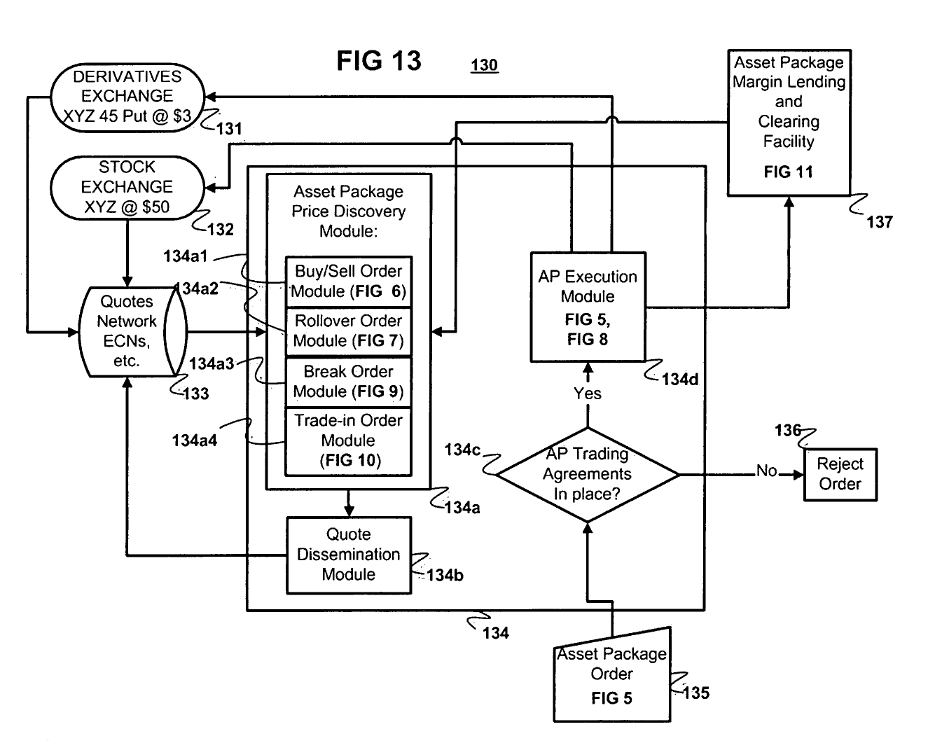

FIG. 13 illustrates the relationships 130 between algorithms and modules of the embodiment of the method and system of the present invention. Thus, the Asset Package Market Maker 134 includes the Asset Package Price Discovery Module 134a, which includes the Buy/Sell Order Module 134a1 shown in FIG. 6, the Rollover Order Module 134a2 shown in FIG. 7, the Break Order Module 134a3 shown in FIG. 9, and the Trade-in Order Module 134a4 shown in FIG. 10. The Asset Package Market Maker 134 also includes the Quote Dissemination Module 134b and the Asset Package Execution Module 134d shown in FIGS. 5 and 8. The Asset Package Market Maker also includes a module 134c to verify the proper trading agreements are in place. If not the order is rejected 136. The Asset Package Order 135 is shown in FIG. 5. The Quotes Network 133 communicates with the Asset Package Price Discovery Module 134a and receives input from the Stock Exchange 132 and the Derivative Exchange 131. The Asset Package Margin Lending and Clearing Facility 137 is shown in FIG. 11.

The above-described methods and apparatuses may be implemented in computer software via servers and clients coupled over a distributed communications networks, including the Internet. Various elements and modules may be included in the same processor or separated depending on other needs. While the above exemplary embodiments are depicted using an equity instrument and a related derivative instrument, other types of assets, rights and liabilities and other types of related assets, rights and liabilities may be employed without departing from the scope of the present invention.

What is claimed is:

1. A computer implemented method for leveraging a hedged synthetic asset package comprising:
linking a centralized margin facility to an asset package market making process; and
embedding leverage achieved through centralized margin lending into a price of a leveraged asset package as a discount.

2. A computer implemented method for processing trades of two or more related assets, rights or liabilities comprising:
creating a market in a combined instrument composed of the two or more related assets, rights or liabilities; and
purchasing one or more of said related assets, rights or liabilities on margin by a market maker as needed to satisfy demand in the market in the combined instrument.

3. A computer implemented method for providing instantaneous leverage of funds when trading a hedged synthetic asset package comprising:
performing a price discovery process of the hedged synthetic asset package;
embedding a margin lending process into the price discovery process; and
conducting leverage upstream relative to the price discovery process.

4. A computer implemented method for trading an asset, right or liability included in an asset package comprising:
providing a centralized margin lending facility that allows incorporating leveraging of funds into a process of price discovery and generation of quotes of market making of asset packages; and
obtaining a virtually risk-free rate of interest charged upfront upon execution of an asset package order.

5. A computer implemented method for trading a combination of an asset, right or liability and a related asset, right or liability comprising:
receiving an order to trade the asset, right or liability and the related asset, right or liability by an asset package market maker that is exempt from a margin requirement; and
creating a market in an asset package composed of the asset, right or liability and the related asset, right or liability based on a purchase of the an asset, right or liability on margin by the asset package market maker.

6. The computer implemented method according to claim 5, further comprising: purchasing the asset, right or liability instrument by the asset package market maker through a centralized margin facility.

7. The computer implemented method according to claim 5, further comprising: embedding leverage achieved by the purchase of the an asset, right or liability instrument by the asset package market maker into a price of the asset package as a discount.

8. The computer implemented method according to claim 5, wherein the purchase of the an asset, right or liability instrument by the asset package market maker on margin is maximized at a value that accounts for any downside protection of the asset, right or liability instrument afforded by the related asset, right or liability.

9. An apparatus for trading instruments comprising:
a market maker to perform a virtual dynamic securitization of a synthetic position into a leveraged asset package; and
a trading order interface coupled to the market maker to accept one or more trades in the leveraged asset package from one or more traders, including one or more non-professional traders.

10. The apparatus according to claim 9, wherein said market maker comprises: an asset package price discovery module to determine a price for the leveraged asset package.

11. The apparatus according to claim 9, wherein said market maker comprises: a quote dissemination module to distribute a quote for the leveraged asset package.

12. The apparatus according to claim 9, wherein said market maker comprises: an asset package execution module to purchase a first type of instrument of the synthetic position on margin from a first exchange and a second type of instrument of the synthetic position from a second exchange that is different than the first exchange.

13. The apparatus according to claim 9, wherein said trading order interface rejects an order if a trading agreement from a trader specified in the order does not exist.

14. The apparatus according to claim 9, further comprising:
a margin lending and clearing facility to finance margin debt on the leveraged asset package incurred by the market maker.

15. A computer implemented method for trading comprising:
generating a quote for an asset package that includes an asset, right or liability and a related asset, right or liability; and
embedding in the quote for the asset package a cost of margin financing of at least one leg of the asset package before the asset package is purchased.

16. A computer implemented method for processing one or more trading orders involving an asset package including a cash or cash equivalent instrument and a related derivative instrument comprising:
performing price discovery for an order involving the asset package by:
collecting a plurality of quotes for the cash or cash equivalent instrument and the related derivative instrument from one or more quotation networks;
calculating a current cost of acquiring the cash or cash equivalent instrument in an underlying market and acquiring the derivative instrument in an underlying derivative market;
calculating a total cost of the asset package, wherein the total calculated cost of the asset package includes the calculated current cost and a spread component of an asset package market maker, which spread component is based on a sum of a national best bid and offer for the cash or cash equivalent instrument and the related derivative instrument and a risk associated with the asset package market maker not being able to fill both legs of the asset package;
calculating a protected cost component (PCC) of the asset package, wherein the PCC defines a portion of a cost of the asset package that can be financed on margin;
calculating an unprotected cost component (UCC) of the asset package, wherein the UCC is calculated as a difference between the cost of the asset package and the PCC, which UCC represents a portion of the cost of the asset package that is exposed to market risk;
qualifying the PCC of the asset package for financing on margin by an asset package margin and clearing facility;
calculating a margin interest component (MIC), wherein the MIC is calculated based on a current margin interest rate data stream provided by an asset package margin and clearing facility and a time to an expiration of the related derivative of the asset package;
determining a final quote for the asset package, wherein the final quote of the asset package is calculated as a sum of the UCC and the MIC; and
transmitting the final quote for the asset package into said one or more quotations networks.

17. The computer implemented method according to claim 16, further comprising:
receiving a buy order in response to a quote of a particular asset package, and executing the received buy order for the particular asset package by:
verifying if the quote of the particular asset package remains valid, wherein if the quote is no longer valid then rejecting the buy order, and if the quote to which the buy order remains valid, then submitting a buy order for the cash or cash equivalent instrument of the particular asset package in a market of the cash or cash equivalent instrument and submitting a buy order for the derivative instrument of the particular asset package in a derivative market of the derivative instrument;
determining if both the buy order for the cash or cash equivalent instrument and the buy order for the derivative instrument have been executed;
if both buy orders have been executed then generating a trade confirmation for the asset package;
if neither of the buy orders have been filled, then generating a no fill report; and
if only one of the buy orders has been filled, then completing the buy order for the asset package at the asset package market maker's risk by filling a remaining leg order at a best market price and upon execution of the remaining leg order generating a trade confirmation.

18. The method according to claim 16, further comprising:
receiving a special order to break up a previously purchased asset package; and
performing price discovery for a break order for the previously purchased asset package by:
calculating a plurality of Unused Margin Interest Components, one for each acceptable synthetic position of the previously purchased asset package, wherein each Unused Margin Interest Component is a product of an original Asset Package MIC charged when the previously purchased asset package was originally purchased and a percentage of a remaining time until expiration of a maximum duration of the previously purchased asset package; and
generating a stream of break order quotes, wherein each break order quote is calculated as a difference between a PCC of the previously purchased asset package and the each of the plurality of calculated Unused Margin Interest Components.

19. The computer implemented method according to claim 16, further comprising:
receiving a rollover order to trade in an existing asset package including an existing derivative and an existing cash or cash equivalent instrument in return for a new asset package; and
performing price discovery for the rollover order of the existing asset package by: generating a plurality of possible rollover scenarios based on a database of existing asset package series, which includes a plurality of asset packages that are currently being quoted or have been traded, and a database of all derivatives that could be potentially used in asset package rollovers; and
for each of the generated plurality of possible rollover scenarios;
calculating a Net Option Replacement Cost (NORC) as a difference between a premium for a derivative of a new Asset Package and a current market value of the existing derivative;
calculating a change in Protection Level (dStrike) as a difference between a new strike price of a new derivative and an original strike price of the original derivative;
if dStrike is less than zero then decreasing the Protection Level and adding dStrike to a cost of the trade in order, wherein dStrike is paid in cash to an Asset Package Margin Lending and Clearing Facility, thereby reducing margin debt associated with the Asset Package;
if dStrike is greater than zero, then increasing the Protection Level and crediting dStrike to a holder of the asset package by the Asset Package Margin Lending and Clearing Facility at a current interest rate;
calculating, based on a real time margin interest data stream from the Asset Package Margin Lending and Clearing Facility, a New Margin Interest Component as a product of a current margin interest, a number of days until expiration of a new derivative, and a new strike price;
calculating an Unused Margin Interest Component as a percentage of an original MIC which has not been fully applied; and
calculating a Change in Margin Interest Component (dMIC) as a difference between the New Margin Interest Component and the Unused Margin Interest Component, which difference represents an adjusted margin interest component for a rolled Asset Package; and
generating a stream of quotes for a plurality of Asset Package Rolling Costs (APRCs), wherein each of the plurality of APRCs is calculated as NORC−dStrike+dMIC for each of the generated plurality of possible rollover scenarios.

20. The computer implemented method according to claim 16, further comprising:
conducting price discovery for one or more Asset Package trade-in orders by:
generating, based on a database of existing Asset Package series, a database of acceptable synthetic positions and then repeating for each acceptable synthetic position:
qualifying an acceptable synthetic position's protected cost component for margin financing, wherein if the acceptable synthetic position does not qualify for margin financing then rejecting the trade-in order and generating and transmitting a ‘No fill’ report, and if the acceptable synthetic position qualifies for margin financing, then calculating a Margin Interest Component of the trade-in package based on a real time margin interest data stream from the Asset Package Margin Lending and Clearing Facility; and
generating a stream of trade-in quotes, wherein an amount to be credited to a trader's account is calculated as a difference between PCC of the trade-in position and the MIC calculated above, which quotes stream is then transmitted into a quotations networks for dissemination.
